(19) United States
(12) Patent Application Publication
(10) Pub. No.: US 2019/0200590 A1
(43) Pub. Date: Jul. 4, 2019

(54) Fishing Lure

(71) Applicant: Douglas William Richardson, Newmarket (CA)

(72) Inventor: Douglas William Richardson, Newmarket (CA)

(21) Appl. No.: 16/230,844

(22) Filed: Dec. 21, 2018

(30) Foreign Application Priority Data
Dec. 28, 2017 (CA) 2,990,503

(51) Int. Cl. A01K 85/10

(52) U.S. Cl. CPC A01K 85/10

(57) ABSTRACT

The present teachings are directed to a novel fishing lure. The lure is configured such that in use it simulates the look and movement of a living fish, which is a target predator fish is attracted to strike.

### FIELD OF THE INVENTION

The present invention is a new fishing lure.

### BACKGROUND OF THE INVENTION

Currently, there are many fishing lures available in the marketplace for commercial and recreational fishing. There are many spinnerbait fishing lures which, through rotational movement of spinner blades during use by anglers create vibrations and sound patterns in the water to mimic small fish or other prey, thereby attracting a targeted predator fish.

The present invention provides a novel fishing lure which uses the motion produced by spinner blades in use to cause movement of a sculpted fish head to realistically simulate the movement and look of a living small prey fish such that targeted predator fish are attracted to strike and be caught, and such that any negative cues to targeted predator fish are minimized.

### DESCRIPTION

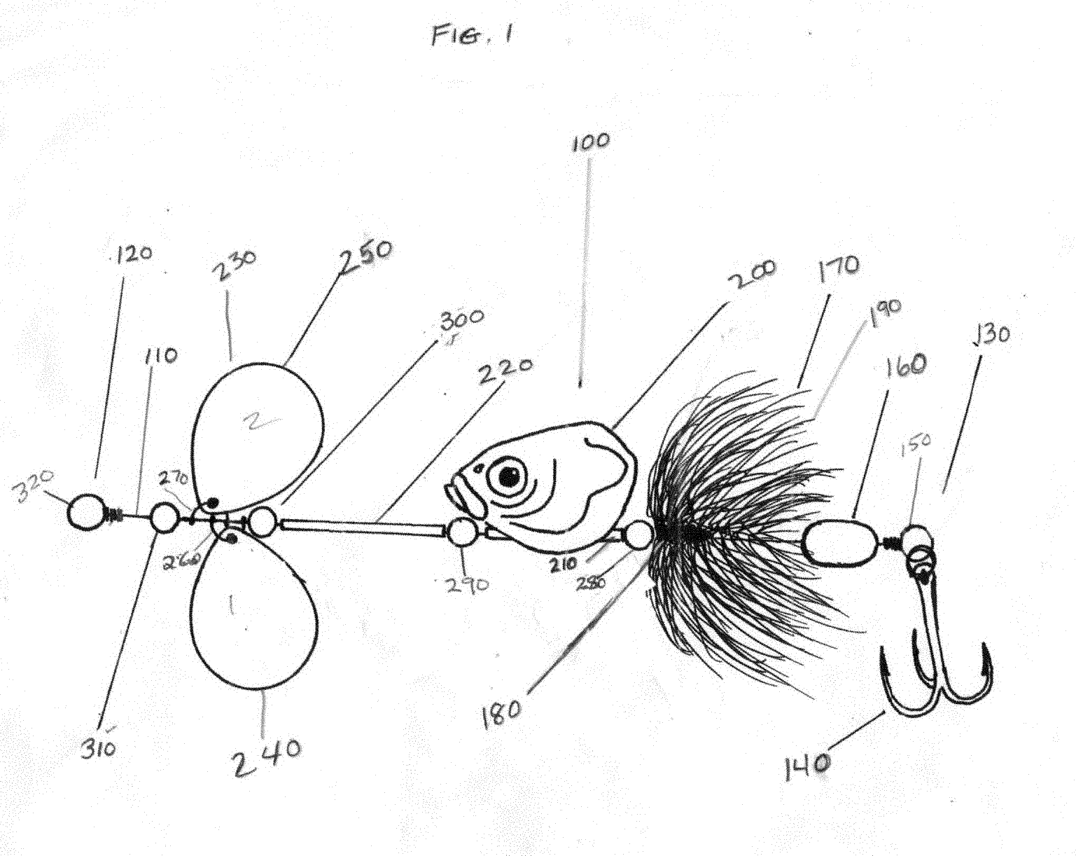

In a preferred embodiment, FIG. 1 shows a fishing lure 100 in accordance with the invention, having a central post member 110 having an anterior end 120 and a posterior end 130. A known fishing hook member 140 is fixedly rotatably attached to said posterior end 130. Anterior to said posterior end 130 is a known sinker 160 fixedly attached to said central post member 110. Anterior to said sinker 160 is a head member 200 fixedly rotatably attached to said central post member 110.

Anterior to said head member 200 is a spacing member 220 fixedly attached to said central post member 110. Anterior to said spacing member 220 is a spinner member 230 rotatably fixedly attached to said central post member 110. Anterior to said spinner member 230 is an attachment means 320 fixedly attached to said central post member.

In a preferred embodiment, said central post member 110 is made of stainless steel wire having a thickness between 0.035 inches and 0.062 inches and length of between 6 and 12 inches depending on the target fish species size and weight.

In a preferred embodiment said attachment means 320 is a closed loop terminus of said anterior end 120 onto which known fishing line is attached by an angler. In an alternative embodiment, said attachment means 320 is a known split ring fixedly attached to said anterior end 120.

In a preferred embodiment said posterior end 130 terminates in a closed loop to facilitate attachment of said fishing hook member 140. In an alternative embodiment a known split ring 150 of appropriate size based proportionate to the size of said fishing hook member 140 is releasably attached to said posterior end 130.

In a preferred embodiment said fishing hook member 140 ranges in size from a known fishing hook size #4 to a known fishing hook size 9/0, and is selected based on the size of the target fish species. In a preferred embodiment, said fishing hook member 140 is releasably rotatably attached to said split ring 150.

In a preferred embodiment a known sinker 160 is fixedly attached to said central post member 110 anterior to said split ring 150. In a preferred embodiment, said sinker 160 is substantially ovaloid made of lead, steel or tungsten, of a weight ranging between ¼ ounce to 1½ ounces (7 grams to 42.5 grams), selected to facilitate casting and to optimize the depth to which said fishing lure 100 will travel downwardly in the water such that the depth to which said fishing lure 100 sinks is a typical swimming depth of the target fish species.

In a preferred embodiment, a skirt member 170 is fabricated in a plurality of tubular members 190 of known silicone, feathers, tinsel, or hair and is releasably tied to a coil member 180 fixedly rotatably mounted to said central post member 110 anterior to said sinker 160. Alternatively said skirt member 170 may be fabricated of solid rubber rather than in a plurality of tubular members 190. In a preferred embodiment said skirt member 170 is trimmed to an appropriate length to prevent interference of said skirt member 170 with movement of said head member 200 in use.

In a preferred embodiment, said coil member 180 is of stainless steel.

In a preferred embodiment said head member 200 is of known hard hollow plastic or plastic composite resin embedded with microballoons, said microballoons being air-filled glass bubbles, said plastic or plastic composite resin having in a preferred embodiment a specific gravity of approximately 0.36 g/cm3 and weight between 7 and 26 grams. In a preferred embodiment said head member 200 is molded and decorated to mimic the natural head of a species of prey fish that a targeted fish would be attracted to as food. In a preferred embodiment, said head member 200 has a length of 1.5 to 3.5 inches and a width of 0.5 to 0.75 inches and a height of 1 to 2 inches but will vary depending on the targeted fish size.

In a preferred embodiment said head member 200 is fixedly attached to a tubular sleeve member 210 fixedly rotatably attached to said central post member 110. In a preferred embodiment, said sleeve member 210 is of aluminum selected from a range of 3/32 inch to ⅛ inch diameter being greater than the diameter of and varying in proportion to the diameter of said central post member 110, such that in use said sleeve member 210 rotates freely around said central post member 110.

In a preferred embodiment said sleeve member 210 is fabricated integral to said head member 200 and disposed at a coronal plane through said head member 200 such that in use substantially 83% of the overall mass of said head member 200 is superior to said sleeve member 210 and such that said sleeve member 210 bisects said head member 200 in the saggital plane. In a preferred embodiment said sleeve member 210 is of a length substantially equal to the length of said head member 200.

In a preferred embodiment, said spinner member 230 is selected such that the length of said spinner member is greater than the height of said head member 200. In a preferred embodiment said spinner member 230 further comprises a first spinner blade 240 and a second spinner blade 250, or alternatively, a plurality of known spinner blades. In a preferred embodiment said first spinner blade 240 and said second spinner blade 250 are known #5 Colorado spinner blades, but Indiana, Willow Leaf and Propeller known spinner blades sized #4 to #10 may be used. In a preferred embodiment, said first spinner blade 240 is fixedly attached to said central post member 110 using a known first clevis 260 preferably fabricated of brass or stainless steel in sizes #4 to #8, and said second spinner blade 250 is fixedly attached to said central post member 110 using a known second clevis 270 preferably fabricated of brass or stainless steel in sizes #4 to #8, to decrease friction on said central post member 110 caused by rotation, in use, of said first spinner blade 240 and said second spinner blade 250.

In a preferred embodiment said spacing member 220 is a known metal or plastic tube or alternatively metal or plastic beads fixedly attached to said central post member 110. In a preferred embodiment the length of said spacing member 220 is selected to be ⅛ inch longer than the distance between the point of attachment of said spinner member 230 to said central post member 110 and a distal end of said first spinner blade 240. In a preferred embodiment the length of said spacing member 220 is selected to be ⅛ inch longer than the distance between a point of attachment of said first clevis 260 to said central post member 110 and a distal end of said first spinner blade 240 measured along the length of said first spinner blade 240 to its most distal point, providing optimal positioning of said head member 200 in use. In a preferred embodiment the length of said spacing member 220 is selected such that an anterior end of said head member 200 is ⅛ inch from a posterior end of said spinner member 230 in use, to optimize positioning of said head member 200 such that there is maximum engagement of said head member 200 with an upward force in water created posterior to said spinner member 230 by the rotation of said spinner member 230 causing rotation of said head member 200 about said central post member 110 to a substantially upright position in use, as further described below. In a preferred embodiment the length of said spacing member 220 is selected such that an anterior end of said head member 200 is ⅛ inch from a posterior end of said spinner member 230 in use so as to avoid interference by said spinner member 230 with rotation and movement of said head member 200 about said central post member 110.

In a preferred embodiment said fishing hook member 140 is fixedly attached at a posterior end of said central post member 110. As will be apparent to those in the art, alternatively, said fishing hook member 140 may be fixedly attached anterior to said skirt member 170 and posterior to said head member 200. Alternatively, as will be apparent to those in the art, a second fishing hook member may be fixedly attached to said central post member 110 posterior to said head member 200 and anterior to said first spacing bead 280 using known means, such as a known split ring. In a preferred embodiment said fishing hook member 140 is of a known size #4 to 9/0, selected based on the size of the targeted fish species.

In a preferred embodiment a first known spacing bead 280 is preferably fabricated of brass and is fixedly attached to said central post member 110 anterior to said skirt member 170. In a preferred embodiment a second known spacing bead 290 is preferably fabricated of brass and is fixedly attached to said central post member 110 anterior to said head member 200 and posterior to said spacing member 220. In a preferred embodiment a third known spacing bead 300 is preferably fabricated of brass and is fixedly attached to said central post member 110 anterior to said spacing member 220 and posterior to said first spinner blade 240 to reduce friction during movement of said first clevis 260. In a preferred embodiment a fourth known spacing bead 310 is preferably fabricated of brass and is fixedly attached to said central post member 110 anterior to said second spinner blade 250 to reduce friction during movement of said second clevis 270. In a preferred embodiment, said first spacing bead 280 and said second spacing bead 290 provide a low friction spacer contact surface between said sleeve member 210 and said spacing member 220. In a preferred embodiment said third spacing bead 300 provides a fixed distance between said first spinner blade 240 and said spacing member 220. In a preferred embodiment said fourth spacing bead 310 provides a fixed distance between an anterior end of said central post member 110 and said second spinner blade 250.

In a preferred embodiment said attachment means 320 is a known split ring, to which known fishing line may be attached by an angler.

In use, said fishing lure 100 is attached to a known fishing line, for example, nylon stren, which is attached to a fishing rod held by an angler. During use, the angler casts said fishing lure 100 into water and drags it in an anterior direction through the water (or, as is known in the art, if the angler is in a boat, the boat's forward movement will cause said fishing lure 100 to be moved in an anterior direction through the water). Such movement in an anterior direction causes rotation of said first spinner blade 240 and said second spinner blade 250. Such rotation causes displacement of water posterior to said first spinner blade 240 and posterior to said second spinner blade 250, which, in accordance with Bernoulli's principle of fluid dynamics, causes a low pressure zone to be created in the water posterior to said first spinner blade 240 and said second spinner blade 250, into which water rushes, the force of which causes rotation of said head member 200 about said central post member 110 to a substantially upright position. With continued anterior movement, said head member 200 continues to be held in a substantially upright position, and also moves laterally and said tubular members 190 move laterally and transversely and rotationally. Such movement causes said fishing lure 100 to simulate lifelike prey fish movement which in use proves to be very attractive to targeted fish species, causing said targeted fish species to bite said fishing hook member 140. When a target fish bites said fishing hook member 140, said targeted fish may be reeled in by the angler.

While the invention has been described with respect to specific embodiments by way of illustration, many modifications and changes will occur to those skilled in the art. For instance, said head member 200 may be crafted in a variety of sizes and weights to create a large or small sized fishing lure, to attract large or small sized targeted fish species, respectively. The material of fabrication and decoration of said head member 200 may be chosen to effect additional known functions such as scent or reflection or light emission to further attract target fish species as is known in the art. Said first spinner blade 240 and said second spinner blade 250 may be of various shapes, sizes, materials and decorations selected to attract particular targeted fish species as is known in the art. Said skirt member 170 may be of various shapes, sizes, materials and decorations selected to attract particular targeted fish species as is known in the art.

Use of the present invention results in a greater rate of catching of targeted fish species by anglers. The above description is intended to be illustrative rather than construed in a restrictive sense, and variations to the specific item described may be apparent to skilled persons in adapting the present invention to specific applications where targeted fish species requires adaptation. Such variations are intended to form part of the present invention insofar as they are within the spirit and scope of the claims below.

What is claimed is:

1. A fishing lure comprising:
a central post member having an anterior end and a posterior end;
a hook member rotationally coupled to said posterior end of said central post member;
a sinker fixedly attached to said central post member;
a head member rotatably attached to said central post member, disposed anterior to said sinker;
a spacing member rotatably attached to said central post member, disposed anterior to said head member;
a spinner member rotatably coupled to said central post member, disposed anterior to said spacing member;
attachment means at an anterior end of said central post member.

2. The fishing lure of claim 1, wherein said head member is fixedly attached to a tubular sleeve member rotatably attached about said central post member.

3. The fishing lure of claim 2, wherein said sleeve member is integral with a portion of said head member.

4. The fishing lure of claim 1, wherein 83% of the total mass of said head member is disposed superior to said central post member and 27% of the total mass of said head member is disposed inferior to said head member.

5. The fishing lure of claim 2, wherein said sleeve member is of equal or greater length than said head member.

6. The fishing lure of claim 1, wherein said head member is comprised of a composite resin or hard plastic.

7. The fishing lure of claim 6, wherein said composite resin is embedded with air-filled glass bubbles, having a specific gravity of 0.36 g/cm3.

8. The fishing lure of claim 1, having a total mass in the range of 7 grams and 26 grams.

9. The fishing lure of claim 1, wherein said head member is sculpted and decorated to mimic the natural head of a selected prey fish.

10. The fishing lure of claim 1, wherein said head member has a length range of 3.81 cm to 8.89 cm, and a width range of 1.27 cm to 1.905 cm and a height range of 2.54 cm to 5.08 cm.

11. The fishing lure of claim 1, wherein said spinner member comprises a plurality of spinner blades.

12. The fishing lure of claim 11, wherein said plurality of spinner blades comprises a first spinner blade and a second spinner blade.

13. The fishing lure of claim 12, wherein said first spinner blade and said second spinner blades are, known #5 Colorado spinner blades.

14. The fishing lure of claim 12, wherein said first spinner blade and said second spinner blade are of equal size, selected from Indiana, Willow Leaf or Propeller known spinner blades sized 4-10.

15. The fishing lure of claim 12, wherein said first spinner blade and said second spinner blade are each rotatably coupled to said central post member using a known brass or steel clevis ranging in size from 4 to 8.

16. The fishing lure of claim 1, wherein said spacing member is 0.3175 cm longer than the maximum length of said spinner member and said maximum length of said spinner member is greater than the height of said head member.

17. The fishing lure of claim 12, wherein said spacing member is 0.3175 cm longer than the maximum length of either of the longer of said first spinner blade or said second spinner blade.

18. The fishing lure of claim 1, wherein said spacing member is a plastic or metal tube.

19. The fishing lure of claim 1, wherein the spacing member is a plurality of plastic beads.

20. The fishing lure of claim 1, wherein said central post member is fabricated of stainless-steel wire having diameter ranging between 0.0889 cm and 0.15748 cm.
